(19) United States
(12) Patent Application Publication
(10) Pub. No.: US 2002/0016175 A1
(43) Pub. Date: Feb. 7, 2002

(54) Method of accessing a service from a mobile telephone using a short-code number

(75) Inventors: Olivier Marce, Massy (FR); Claire Bazin, Paris (FR)

Correspondence Address: SUGHRUE, MION, ZINN, MACPEAK & SEAS, PLLC, SUITE 800, 2100 Pennsylvania Avenue, N.W., Washington, DC, 20037-3213, US

(73) Assignee: ALCATEL

(21) Appl. No.: 09/880,755

(22) Filed: Jun. 15, 2001

(30) Foreign Application Priority Data
Jun. 22, 2000 (FR) 00 08 015

(51) Int. Cl. H04Q 7/20

(52) U.S. Cl. 455/466; 455/435; 455/412; 455/418

(57) ABSTRACT

In a method of accessing from a mobile telephone one of a set of services stored in a telecommunication network associated with the mobile telephone, the service is determined by the geographical location of the mobile telephone and a service request including a short-code number supplied to the user of the mobile telephone.

### CROSS-REFERENCE TO RELATED APPLICATIONS

This application is based on French Patent Application No. 00 08 015 filed Jun. 22, 2000, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a method of accessing a locally accessible service from a mobile telephone. It applies particularly well to cellular networks such as those conforming to the GSM standard of the ETSI (European Telecommunication Standards Institute).

2. Description of the Prior Art

Various services can be accessed from a mobile telephone, for example a mobile telephone conforming to the GSM standards. The services can have larger or smaller geographical coverage areas.

Clearly a service enabling the mobile telephone user to access banking information must have the largest possible geographical coverage area, i.e. it must be accessible from wherever the user is located.

Conversely, other services are purely local services of interest only if the user is in a particular geographical area.

Examples of local services include the provision of information relating to commercial establishments in that geographical area (restaurants, cinemas, stores, etc.) or to an event, museum, monument, etc.

Another example of a local service would be one adapting a large coverage service to a more restricted geographical area. This category includes weather and traffic information, for example.

The services can be interactive and can require exchange of information with the user via their mobile telephone or a monodirectional transfer of information to the telephone.

In the ordinary way, to access local services, the user of a mobile telephone has to employ the services of a human operator who analyzes their request and routes it to the corresponding available services. This approach is costly in terms of time and/or resources and gives rise to the problem of locating the user: it is not always easy for the user to give the operator their precise geographical position.

It also obliges users to converse with an operator, although they are not necessarily in a position to do so. For example, the user might be in a vehicle passing a store and want to find out more about the store by using a service accessible via their mobile telephone. In this case, if access to the services requires more than a few very simple operations, the user must stop for considerable time, which is not necessarily possible or desirable.

Another approach is to use location mechanisms employing the GPS (Global Positioning System) integrated into mobile telephones and relieving the user of the need to know their location. Apart from the fact that such mechanisms are generally costly, they do not constitute a good response to the problem of obtaining access to the service. Although they free the user of location problems, they hardly simplify access to the service, because the user needs to know the telephone number providing access to the required service. If the telephone number is shown on the facade of a commercial establishment and the user is merely driving past, it may be difficult for the user to memorize the telephone number.

To solve this problem, the invention proposes to use short-code numbers which, in conjunction with location information, enable the user to access local services easily and quickly.

### SUMMARY OF THE INVENTION

To this end, the invention provides a method of accessing from a mobile telephone one of a set of services stored in a telecommunication network associated with the mobile telephone, in which method the service is determined by the geographical location of the mobile telephone and a service request including a short-code number supplied to the user of the mobile telephone.

The invention also provides a control station for implementing the method.

Using the method in accordance with the invention, to provide direct access to information about a store it is only necessary for the storefront to display a short-code number (comprising two or three digits). The short-code number identifies a single service in a given geographical area. That geographical area can correspond to the coverage area of a control station in the case of a cellular network, for example.

The short-code number is easy to enter and memorize so that even users passing the store quickly and unable to stop (for example because they are traveling by public transport) can access the service.

The short-code number is also easy to dial, even for a user occupied with some other activity.

The invention, its features and its advantages will become more clearly apparent in the course of the following description of a few embodiments of the invention, which description is given with reference to the accompanying drawing.

### BRIEF DESCRIPTION OF THE DRAWING

FIG. 1 shows a first embodiment of the invention.

FIG. 2 shows a second embodiment of the invention.

### DETAILED DESCRIPTION OF THE PREFERRED EMBODIMENTS

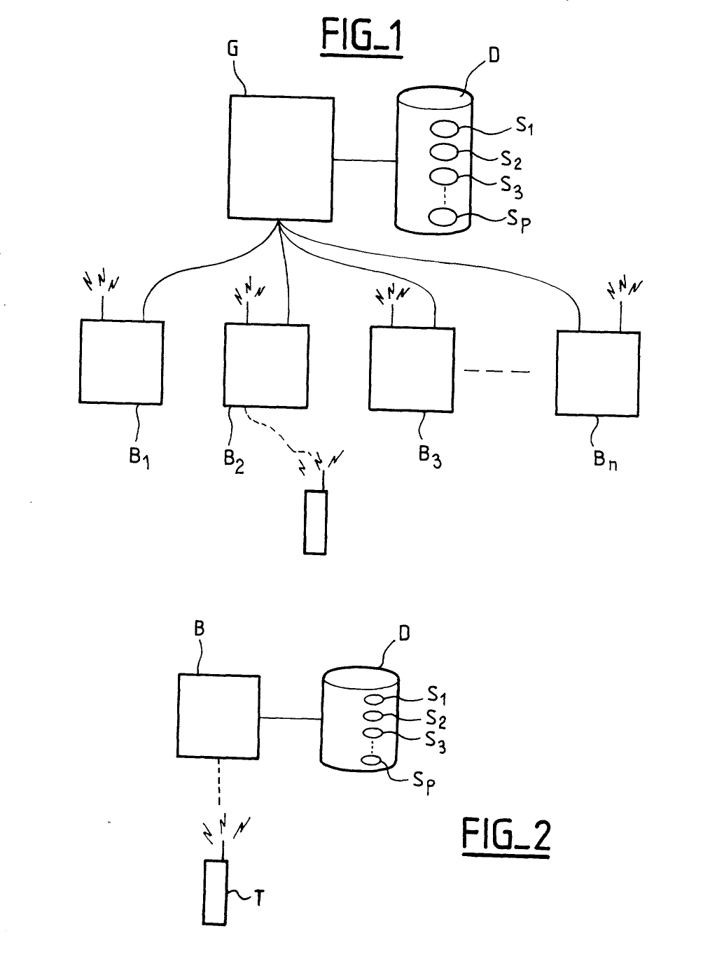

FIG. 1 shows a set of control stations B₁, B₂, B₃ . . . Bₙ. The mobile telephone T is temporarily connected to the single control station B₂.

The control stations are themselves connected via a telecommunication network to a centralized manager G. The centralized manager G is associated with a database D containing a set of services S₁, S₂, S₂ . . . Sₚ.

In a telecommunication network conforming to the specifications set out in the GSM standards, the control stations B₁, B₂, B₃ . . . Bₙ are referred to as base transceiver stations and their coverage area is conventionally called a cell.

As in the embodiment shown in FIG. 1, the first step of the method is for the user to enter the short-code number. The short-code number is transmitted as the content of a service request sent by the mobile telephone T to the control station B₂ to which it is connected at the time.

The service request is typically a message whose body includes the entered short-code number. The message is of the same type as those used to request the setting up of a normal call. The message is analyzed in the control station, recognized as a short-code number corresponding to a service request, and processed as such.

On receiving the service request, the control station B₂ transmits to a centralized manager G a message including the short-code number supplied by the mobile telephone and information relating to the location of the mobile telephone.

The information relating to the location of the mobile telephone can take different forms.

In a first embodiment, it can simply be the identifier of the control station B₂ in question. Each control station is associated with a geographical area corresponding to its coverage area. Accordingly, if the identifier of the control station to which a mobile telephone is connected is known, the geographical area in which it is located can be deduced. The accuracy of this location, although only moderate, proves sufficient in most cases.

In a second embodiment prior art methods can be used to determine the geographical location of the mobile telephone more precisely. The GPS, previously referred to, may be cited as one example of this. Another is triangulation methods based on radio signals exchanged between the mobile telephone and a plurality of radio stations.

In this case, the mobile telephone or the control station can determine the location of the mobile telephone and transmit it to the control station B₂ to which it is connected, together with the short-code number.

Triangulation methods are described in “Mobile positioning, An introduction”, Mobile Lifestreams, December 1999, for example.

Other methods that do not depart from the scope of the invention are obviously available to the skilled person.

On receiving the message from the control station B₂, the centralized manager knows a short-code number and the location of the mobile telephone T. That information is necessary and sufficient to identify a single local service in the set of services S₁, S₂, S₃ . . . S_{P} stored in the database D associated with the centralized manager G.

To this end, the centralized manager G can, for example, hold a table establishing the correspondence between the location plus short-code number pairs and an identifier of the corresponding service in the database D. That identifier can be a pointer, for example.

If the location is given by the identifier of the control station, this kind of table can take the following form:

| Control station | Short-code | |
|---|---|---|
| identifier | number | Service |
| 1 | 42 | Service 1 |
| 1 | 57 | Service 2 |
| 1 | 38 | Service 3 |
| 2 | 42 | Service 4 |
| 3 | 5 | Service 5 |

Note that in this table the same short-code number (42) provides access to different services, depending on the location of the mobile telephone.

The short-code number is significantly shorter than an ordinary telephone number. This enables the short-code number to be memorized quickly and entered quickly on a keypad (or other input device) of the mobile telephone T.

It is possible to use a short-code number because that number determines a service within a geographical area of limited size. This is based on the fact that the number of services in a limited geographical area is itself limited, so that a short-code number is sufficient to identify it.

FIG. 2 shows a second embodiment of the invention.

FIG. 2 shows a mobile telephone T, a control station B and a database D containing services S₁, S₂, S₃ . . . Sₚ.

In a first step, the user of the mobile telephone T enters a short-code number. That short-code number corresponds to a service available in the geographical area in which the user is located at the time the short-code number is entered.

As previously stated, the short-code number can be displayed on the facade of a commercial establishment to enable users passing nearby to find out about the service they can access.

The short-code number can also be transmitted to the user by the network itself (see below).

Once the user has entered the short-code number, the mobile telephone T transmits a service request to the control station to which it is connected. The service request is typically a message whose body contains the entered short-code number. The message is of the same type as those used to request the setting up of a normal call. The message is analyzed in the control station, recognized as a short-code number corresponding to a service, and processed as such.

On receiving the service request the control station B determines which of the services S₁, S₂, S₃ . . . Sₚ stored in its database D corresponds to the received short-code number.

To this end, the control station B can, for example, hold a table establishing the correspondence between each short-code number and an identifier of the corresponding service in the database D. The identifier can be a pointer, for example.

This greatly facilitates service maintenance. A service is added or modified by modifying the local database D, which is much less costly than modifying a central database, as in the FIG. 1 embodiment.

It also limits traffic on the telecommunication network, because service requests are processed locally by the control stations, without generating traffic between the control stations and a centralized manager. In one embodiment of the invention the telecommunication network can supply the user with short-code numbers corresponding to services available in the geographical area in which they are located. This can be done by means of SMS (Short Message Service) text messages in the context of the GSM standards.

The short-code numbers can be supplied at the request of the user, for example, or automatically when the user enters a new geographical area (i.e. at the time of handover, for example).

The service can be enriched by using a predefined user profile, for example one produced by the user himself, so that the short-code numbers transmitted to the user correspond to services that match the user profile.

Thus tourists can specify in their user profiles that they are interested in receiving the short-code numbers of services concerning monuments and museums. As the users walk around, they will be automatically advised of numbers of services corresponding to monuments and museums in their immediate vicinity.

There is claimed:

1. A method of accessing from a mobile telephone one of a set of services stored in a telecommunication network associated with said mobile telephone, in which method said service is determined by the geographical location of said mobile telephone and a service request including a short-code number supplied to the user of said mobile telephone.

2. The method claimed in claim 1 wherein, on receiving said service request, a control station to which said mobile telephone is connected supplies said short-code number and information relating to said geographical location of said telephone to a centralized manager associated with a central database.

3. The method claimed in claim 2 wherein said information relating to location is an identifier of said control station.

4. The method claimed in claim 1 wherein said services are stored in a local database associated with said control station to which said mobile telephone is connected.

5. The method claimed in claim 1 wherein short-code numbers are communicated to said mobile telephone in SMS messages so that the user can take note of them.

6. The method claimed in claim 5 in which said user produces a predefined user profile so that only short-code numbers corresponding to services matching said user profile are transmitted to said user.

7. A control station in a telecommunication network including means for communicating with a set of mobile telephones further including means for implementing a method of accessing from a mobile telephone one of a set of services stored in a telecommunication network associated with said mobile telephone, in which method said service is determined by the geographical location of said mobile telephone and a service request including a short-code number supplied to the user of said mobile telephone.

8. The control station claimed in claim 7 wherein, on receiving said service request, a control station to which said mobile telephone is connected supplies said short-code number and information relating to said geographical location of said telephone to a centralized manager associated with a central database.

9. The control station claimed in claim 8 wherein said information relating to location is an identifier of said control station.

10. The control station claimed in claim 7 wherein said services are stored in a local database associated with said control station to which said mobile telephone is connected.

11. The control station claimed in claim 7 wherein short-code numbers are communicated to said mobile telephone in SMS messages so that the user can take note of them.

12. The control station claimed in claim 11 in which said user produces a predefined user profile so that only short-code numbers corresponding to services matching said user profile are transmitted to said user.
